(19) United States
(12) Patent Application Publication
(10) Pub. No.: US 2020/0021453 A1
(43) Pub. Date: Jan. 16, 2020

(54) INCREASING AUDIENCE ENGAGEMENT DURING PRESENTATIONS BY AUTOMATIC ATTENDEE LOG IN, LIVE AUDIENCE STATISTICS, AND PRESENTER EVALUATION AND FEEDBACK

(71) Applicant: DialogLoop Inc., Calgary (CA)

(72) Inventors: Dinesh Advani, Calgary (CA); Emmanuel Gueritte, Vaucresson (FR)

(21) Appl. No.: 16/510,288

(22) Filed: Jul. 12, 2019

Related U.S. Application Data
(60) Provisional application No. 62/698,613, filed on Jul. 16, 2018.

(51) Int. Cl. H04L 12/18; H04H 60/33

(52) U.S. Cl. CPC H04L 12/1827; H04H 60/33; H04L 12/1818; H04L 12/1822

(57) ABSTRACT

A presentation system includes a control server coupled to a presenter device via a network. The server receives a slide deck from the presenter device and calculates slide identifiers and analyses the slide deck to provide pre-presentation tips to the presenter. Attendee devices may log in to the presentation to receive a copy of the slide deck and to interact with the presenter and other attendees. In automatic log in, an attendee device is utilized to take a picture of a current slide or sample audio of the ongoing presentation. A slide recognition engine on either or both of the attendee device or the control server matches the data from the attendee device to a slide database to determine the presentation session and automatically log in the attendee. During the presentation, the control server automatically populates dynamic slides based on statistics from the audience including engagement and feedback items.

### CROSS-REFERENCE TO RELATED APPLICATIONS

This application claims the benefit of priority of U.S. Provisional Application No. 62/698,613 filed Jul. 16, 2018, which is incorporated herein by reference.

### BACKGROUND OF THE INVENTION

### (1) Field of the Invention

The present invention relates to corporate, professional, educational, and other group settings having in-person conferences and face-to-face meetings. More specifically, the technical field relates to the use of Internet-based software and Internet-enabled digital devices to stream, share and enhance presentation content with audience members/attendees and to provide feedback regarding audience engagement and tips for improvement to the presenter.

### (2) Description of the Related Art

At a conference, attendees may be requested to connect to an online session for participating in polls or surveys conducted during the presentation or for other benefits such as to view or save a copy of the slides. At many events, there are multiple ongoing sessions and the attendee must find the correct session on their device to log in and join. The event may have a software application or website that provides access to each session; however, when there are multiple simultaneous sessions such as different break-out session, it can be difficult for attendees to know which session to electronically join on their device. In some cases, the attendee may randomly enter the room of an ongoing session without knowing the title of that session.

Paper guides with codes or uniform resource locators (URLs) for each session may be provided to attendees at event check-in; however, it is time consuming and inconvenient to require attendees to search sessions in a paper guide. Quick response QR codes (QR Code is a registered trademark of Denso Wave Incorporated) or other uniform resource locators (URLs) may be displayed on a slide by the presenter such as the first slide; however, a late attendee does not benefit when the slides have already progressed past the first slide before the attendee has arrived. Likewise, it is inconvenient to require attendees to find QR codes and some attendees may not have a QR code scanner on their mobile device or may not know how to use it. Session login links can be sent to the attendees via short message service (SMS) or email; however, sending messages to attendees requires that the presenter or event organizer to know each respective attendee's contact information. Some attendees may not preregister. Likewise, some attendees may change their mind about which session to attend during the event and may switch sessions.

So-called “death by PowerPoint” is another problem with presentations. The repetitive and relentless nature of slides shown in sequence tends to bore audience members. In many cases, the presenter is oblivious. Even if the presenter is aware of the situation, it can be difficult for the presenter to remedy the situation and regain audience attention. The presenter may try to tell an engaging story or ask the audience questions; however, these solutions require the presenter to have an interesting story or engaging questions to raise. Another technique involves the presenter drawing tickets from a bowl/bucket in order to award prizes; however, this requires selling or giving away tickets. There are monetary and time costs associated with doing prize draws during a presentation.

Yet another problem with typical presentations is the lack of honest feedback to the presenter. Presenters delivering a presentation to a live audience may have difficulties self-evaluating what was good or bad in their presentation, obtaining accurate quantitative or qualitative feedback about their presentation, and learning concrete and actionable ways to improve their presentation for next time. Post-presentation surveys are often used to solicit feedback, but survey participation can be low and even with anonymous surveys people tend to tell “white lies” in a counterproductive attempt to support the presenter and avoid hurting the presenter's feelings. The presenter may make a video recording of themselves doing the presentation, but, without the expertise to understand what went wrong, many presenters are still not be able to significantly improve on their own. To obtain objective feedback and really make improvement, the presenter may need to engage the services of a costly professional coach or try to find a brutally honest colleague or family member who has experience doing successful presentations.

### BRIEF SUMMARY OF THE INVENTION

According to an exemplary embodiment of the invention there is disclosed a system and method for allowing attendees to automatically log in or otherwise join and access resources of a presentation by performing live visual recognition of slides. Automatic login helps get audience members quickly joined into the session's online platform and facilitates audience engagement and allows feedback. The resources may include slides, images, and any supplementary resources associated with the presentation including content that is generated during the presentation based on input from either the presenter and/or the audience.

According to another exemplary embodiment of the invention there is disclosed a system and method for providing dynamic slides that are based on live audience statistics and engagement triggers in real time during the presentation. Capturing and analysing data about the audience members allows the presenter to identify interesting traits of the group as whole, which can be used by the presenter to make each presentation feel more personal and unique. In addition, creating live data of a group of people raises the audience's attention level to the maximum, and acts as an engagement motivator. For instance, attendees may think to themselves, “I want to be part of the live statistics.” The live statistics work to increase the number of participators, because they do not want to be left alone and out of the group, and they want to see how they contribute to the statistics.

According to yet another exemplary embodiment of the invention there is disclosed a system and method for providing concrete and actionable evaluation and tips for improvement to the presenter, both before, during, and after the presentation. Feedback and tips to the presenter help speakers improve thereby increasing both audience enjoyment and future presentation opportunities.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 shows a block diagram of a system for facilitating in-person presentations according to an exemplary embodiment.

FIG. 2 illustrates UI screens of an attendee device joining an ongoing presentation utilizing an automatic attendee log in function accessed on a mobile phone according to an exemplary embodiment.

FIG. 3 illustrates a floor plan view of a conference centre hosting three simultaneous presentations in three respective rooms according to an exemplary embodiment.

FIG. 4 illustrates a table linking slide images to codes that is calculated and stored in order to automatically associate data captured by the attendee device with a particular presentation.

FIG. 5 shows a flowchart of a method of automatically logging in an attendee device to an ongoing presentation according to an exemplary embodiment.

FIG. 6 illustrates a sequence of UI screens for setting up and displaying a dynamic slide showing live audience statistics according to an exemplary embodiment.

FIG. 7 illustrates an attendee wall that shows the names and social media profile picture for each currently logged in attendee according to an exemplary embodiment.

FIG. 8 illustrates an age pyramid of the attendees logged in to the event according to an exemplary embodiment.

FIG. 9 illustrates another form of the “where from” widget that shows the origin locations for each logged-in attendee on a world map according to an exemplary embodiment.

FIG. 10 illustrates a gender graph with different colors showing categories for each gender of logged in attendee according to an exemplary embodiment.

FIG. 11 shows a word cloud of the various job titles and types of the logged-in attendees during the presentation according to an exemplary embodiment.

FIG. 12 illustrates a crowd influence chart showing the number of various social media site followers and users currently logged in to the presentation according to an exemplary embodiment.

FIG. 13 shows a flowchart of a method of generating and updating dynamic slides based on external events during the presentation according to an exemplary embodiment.

FIG. 14 illustrates a feedback UI screen showing an event timeline to the presenter regarding a presentation according to an exemplary embodiment.

FIG. 15 illustrates a second feedback UI screen that plays a recording of the presentation to the presenter along with subtitles providing comments and tips to improve the presentation in the future.

FIG. 16 shows a flowchart of a method of providing presenter evaluation and feedback according to an exemplary embodiment.

### DETAILED DESCRIPTION

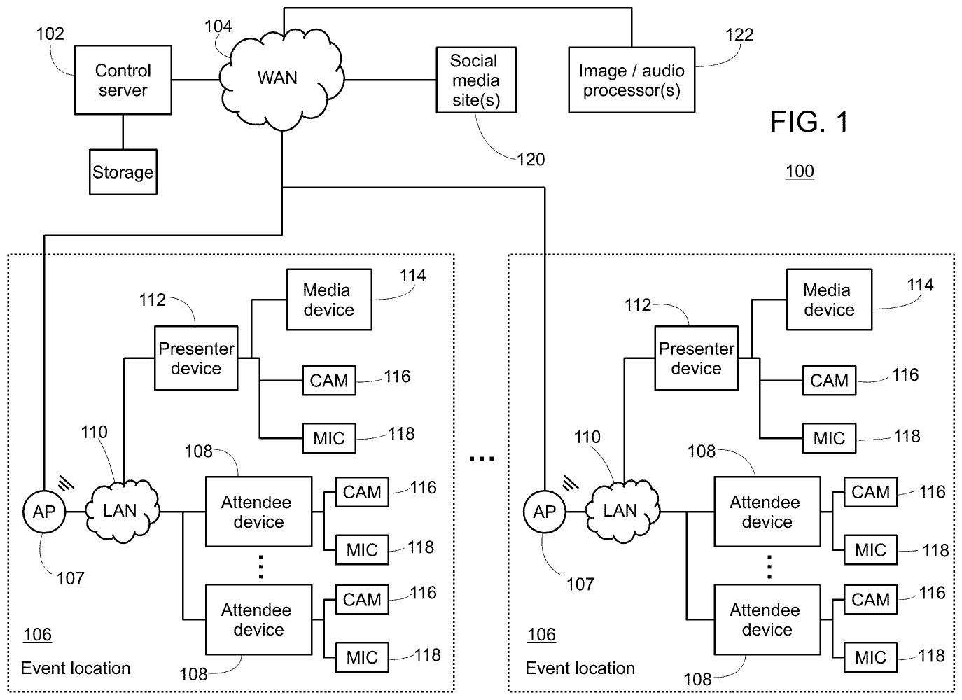

FIG. 1 shows a block diagram of a system 100 for facilitating in-person presentations according to an exemplary embodiment. The system 100 includes a control server 102 coupled to a wide area network (WAN) 104 such as the Internet. A plurality of event locations 106 such as conference centers hosting presentation sessions each include an access point (AP) 107 providing a wireless local area network (LAN) 110 at the event location 106. A plurality of attendee devices 108 such as mobile phones and laptop computers are coupled to the LAN 110. A presenter device 112 such as a laptop computer is also coupled to the LAN 110 and provides slide playback on a media device 114 such as a projector screen. Other types of media devices 114 may be included such as speakers or any other desired audiovisual (AV) device.

In this embodiment, each of the presenter device 112 and attendee devices 108 includes or is coupled to a camera 116 such as a webcam and a microphone 118. Social media webservers 120 are also coupled to the WAN 104 and are accessible to the presenter and attendee devices 112, 108 via the AP 107. Other network equipment such as gateways and switches (not shown) may be included as required to facilitate communication between devices 112, 108 on the LAN 110 to the devices 102, 120 on the WAN 104. In general, the wiring of FIG. 1 is intended as an example to facilitate explanation, but of course other connections may be employed as needed. For instance, more and more media devices 114 such as projectors and the like are coupled to the presenter device 112 via the LAN 110 rather than directly. This change is made to FIG. 1 in other embodiments.

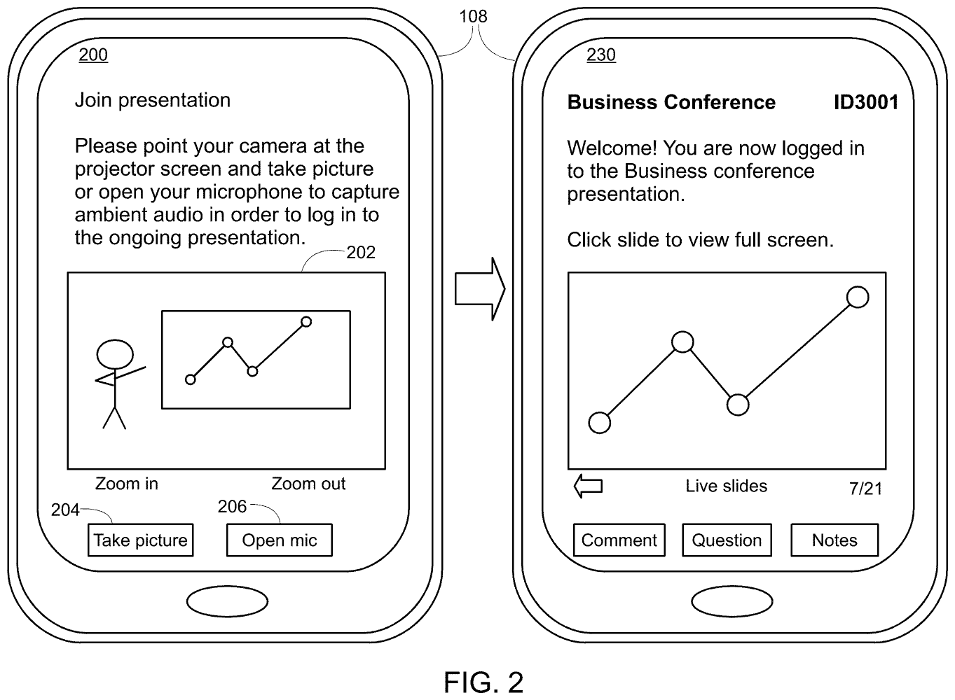

FIG. 2 illustrates UI screens 200, 230 of an attendee joining an ongoing presentation utilizing an automatic attendee log in function accessed on an attendee device 108 being a mobile phone according to an exemplary embodiment. A first UI screen 200 shown on the left side of FIG. 2 is an example of what the user sees upon opening either a software application or web browser to access a presentation system provided by the control server 102 in FIG. 1. The control server 102 may provide any number of functions related to ongoing presentations. In just one example, upon logging in to a presentation, the control server 102 may send an electronic copy of the slides to the user's device 108. In this way, the user can follow along, take notes, and save the slides and notes for later review on their mobile device 108 during or after the presentation is over. Examples of functions that may be provided by the control server 102 to facilitate audience engagement and the presentation effectiveness in general are provided in Published United States Patent Application No. 20180145840 bearing publication date May 24, 2018, which is incorporated herein by reference.

As illustrated in the join presentation UI screen 200 of FIG. 2, the user has not yet logged in to any specific presentation and therefore the control server 102 does not yet know which set of slides to send to the user's device 108. The UI screen 200 asks the user to join a presentation by either taking a picture of the ongoing presentation slides and/or by opening the microphone 118 on the mobile phone in order to capture and send a sample of the ambient audio within the presentation room to the control server 102. The UI screen 200 may display a preview 202 of the picture to allow the user to ensure that the slides are clearly visible to the camera 116 lens. Zoom in and zoom out buttons control digital and/or analog zoom functions provided by the mobile phone 108. When the slides are lined up in the camera preview 202, the user can press the take picture button 204 to take the picture. In some embodiments, one or more processors of the mobile phone or another type of attendee device 108 may automatically take the picture as soon as the slides are properly aligned in the camera preview window 202. Likewise, to start recording an audio sample, the user may press the open mic button 206. Again, in some embodiments, the mic 118 may be automatically opened by the processor(s) of the attendee device 108 as soon as the join presentation UI screen 200 is opened. Data samples of either image, video, and/or audio captured by the attendee device 108 while UI screen 200 is opened are sent over the LAN 110 and WAN 104 networks to the control server 102.

The logged in UI screen 230 on the right-hand side of FIG. 2 illustrates the result after the control server 102 has received the data sample captured by the attendee device 108 and has automatically logged the user into a presentation that corresponds to the captured data sample. As illustrated, the logged in UI screen 230 indicates the name of the ongoing presentation along with the current slide. Previous slides that have already been shown are also sent by the control server 102 to the attendee device 108 and can be viewed by the user. Comments, questions, and note taking functionality related to the presentation are available. The user is now logged in to the presentation and can participate and keep copies of the slides and/or perform any other functionality that is provided by the control server 102 and the app/web app displayed by the attendee device 108.

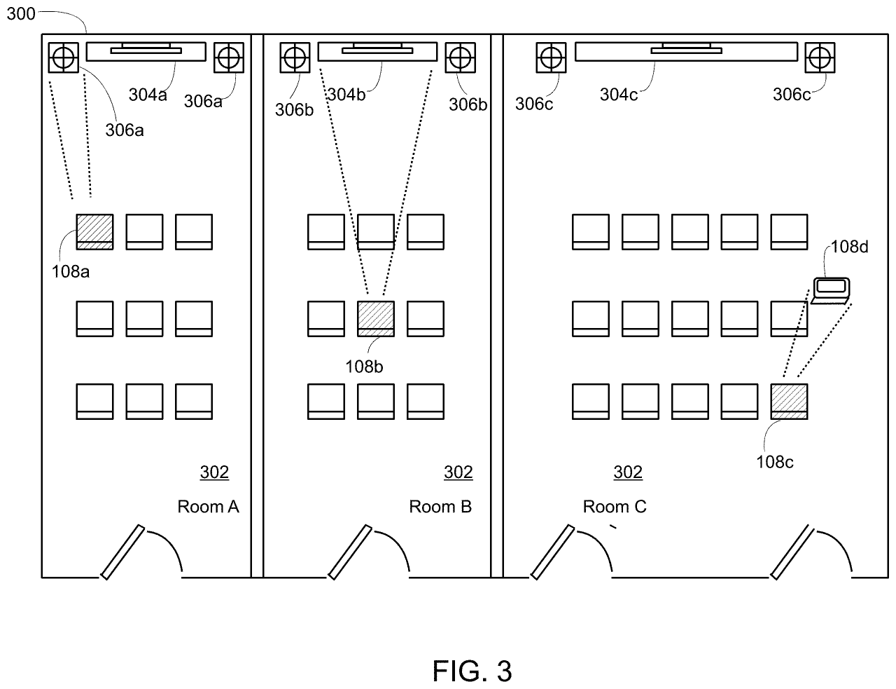

FIG. 3 illustrates a floor plan view of a conference centre 300 hosting three simultaneous presentations in three respective rooms 302 according to an exemplary embodiment. Each room 302 has a projection screen 304 showing slides and a plurality of speakers 306 amplifying audio by the presenter. The projection screens 304 and speakers 306 are examples of the media devices 114 illustrated in FIG. 1.

In the “A” room 302, a first attendee device 108a automatically logs in to the presentation ongoing in the “A” room 302 by capturing an audio sample from one of the speakers 306a. This may be performed by the user of the first attendee device 108a utilizing the open mic button 206 shown in the join presentation UI screen 200 of FIG. 2, for example. In the “B” room, a second attendee device 108b automatically logs in to the presentation ongoing in the “B” room 302 by taking a picture or video of the projector screen 314b showing slides by the presenter. This may be performed by the user of the second attendee device 108b pointing the camera 116 of the device 108b at the projector screen 314b and pressing the take picture button 204 shown in the UI screen 200 of FIG. 2. Finally, in the “C” room 302, a third attendee device 108c automatically logs in to the presentation ongoing in the “C” room by taking a picture or video of a fourth attendee's device 108d visible to the third attendee device 108c. In this example, the third attendee device 108c perhaps does not have a direct line of sight to the projector 304c due to a pillar blocking the view; however, the third attendee device 108c does have a direct line of sight to another attendee's device 108d showing the slides, which may be as a result of the other attendee's device 108d showing the logged in UI screen 230 illustrated earlier in FIG. 2. Again, the user of the third attendee device 108c may simply point their device's 108c camera 116 at the other user's screen and press the take picture button 204 in order to also get logged in to the presentation.

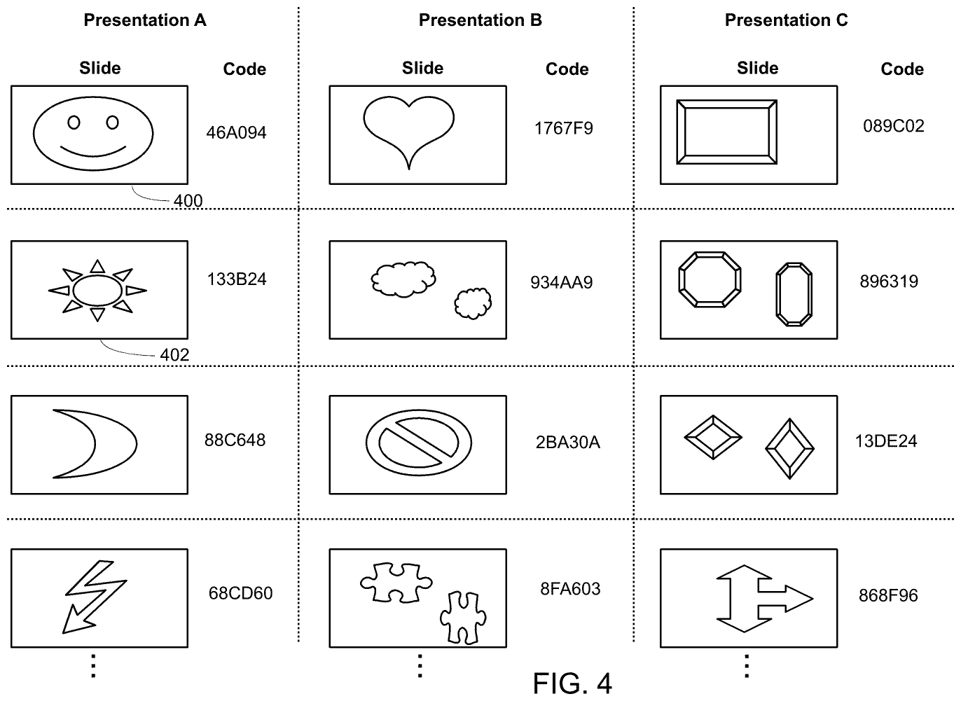

FIG. 4 illustrates a table linking slide images to codes that are calculated and stored on one or both of the control server 102 and/or attendee device 108 in order to automatically associate data captured by the attendee device 108 with a particular presentation. As illustrated, each presentation in the floor plan of FIG. 3 has a separate column in the table of FIG. 4. The slides in presentation are shown in respective rows, and each slide has a code associated therewith. For instance, the first slide 400 in presentation A is associated with code “46A094”, the second slide 402 in presentation A is associated with code “133B24” and so on. Each slide is associated with a code. Although the codes for each slide are unique in FIG. 4, this is because there are no duplicate slides illustrated in the sample of FIG. 4. If two slides are exactly the same, it may be the case that codes will also match.

In some embodiments, the codes are calculated using a hash function that converts an image representation of the slide to a hash value that identifies that image from other different images. Image resolution settings and other image preprocessing may be performed by processor(s) of either the control server 102 and/or the attendee device 108 in order accommodate for differences in angles, zoom settings, and other variations that might be caused by different attendee devices 108 taking a picture of the same slide. In this way, variations in the angle the picture was taken or the zoom or the distance will not affect the code calculated for slide. Any suitable coding algorithm may be employed, but the goal is to return a same code value for a particular slide regardless of differences in the way the attendee device may have taken the picture of the slide.

Rather than or in addition to a hashing function, in other embodiments, different types of image recognition algorithms may be employed to generate a code or other type of identifier for each slide in the presentations. For instance, graphical analysis can be performed (by either the control server 102 or the attendee device) to identify text, objects, colors, patterns, or any other desired element within the image. Optical character recognition techniques can extract the text of the slide, color filters can extract the colors, etc. The code for each slide may include a variety of information about the slide including the text present on the slide, the colors, objects recognized or detected, the different patterns detected etc. By matching all the information detected within a new data sample (i.e., a picture of a slide taken by an attendee device 108), a composite code or other plurality of slide identifiers can be generated that together identify the slide by matching with table in FIG. 4.

As mentioned, the computing of the codes or other identifiers for each slide can be performed by either or both of the control server 102 and the attendee device 108. In some embodiments, the presenter device 112 will upload a copy of the slide deck to the control server 102 for distribution to the attendee devices 108 associated with the presentation. The control server 102 will then calculate a slide code or other identifier for each slide in the slide deck and store these codes within a storage device 124. In other embodiments, this can be also be performed or pre-computed on the presenter's device 114 before uploading to the control server 102. Thereafter, when an attendee device 108 not currently associated with any prestation sends a data sample such as a picture taken of a slide in one of the presentations shown in the floor plan of FIG. 3, the control server 102 can compute a slide code or other identifier for the received data sample and then search the table of FIG. 4 in order to find a match. If a match is found, the control server 102 can then associate the attendee device 108 with the correct presentation and send all the appropriate information related to that presentation to the attendee device 108. In another embodiment, the attendee device 108 itself can compute the slide code or other identifier for the data captured by the attendee device 108 and simply send the resulting code or identifier to the control server 102. In this way, computational work such as the image processing, graphical analysis, OCR, hashing functions, are offloaded from the control server 102 to the attendee device 108. In some embodiments, the decision of whether the attendee device 108 or the control server 102 computes the code or other slide identifier for the captured data sample is made dynamically according to the capabilities of the attendee device 108.

In yet other embodiments, the computation of the slide codes or other identifiers may be made by one or more third-party image/audio processors 122. For instance, external processing servers 122 on WAN 104 may provide various application programming interfaces (APIs) providing image and/or audio recognition. Amazon image recognition library provided by Amazon Web Services (AWS) is an example of an external image processor 122. In some embodiments, either of the attendee device 108 and the control server 102 sends an image to the external image processor 122 (i.e., AWS image recognition library) and receives a code or other identifier back. For example, the control server 102 may send images to the external processor 122 upon receiving the slide deck from the presenter device 112 in order to generate and save the table of FIG. 4. Likewise, the control server 102 may send data samples of images taken by an unassociated attendee device 108 to the external processor and then match the code or other identifier received back from the image processor 122 with one of the code values in FIG. 4 in order to associate that attendee device 108 with an ongoing presentation. In another example, the attendee device 108 itself may send image data captured by its camera 116 directly to the external image processor 122 and then receive back a code or other identifier. The code or other identifier is then sent to the control server 102 thereby allowing the control server 102 to associate the attendee device 108 with a particular one of the ongoing presentations by matching the code or other identifier to an existing slide in the table of FIG. 4.

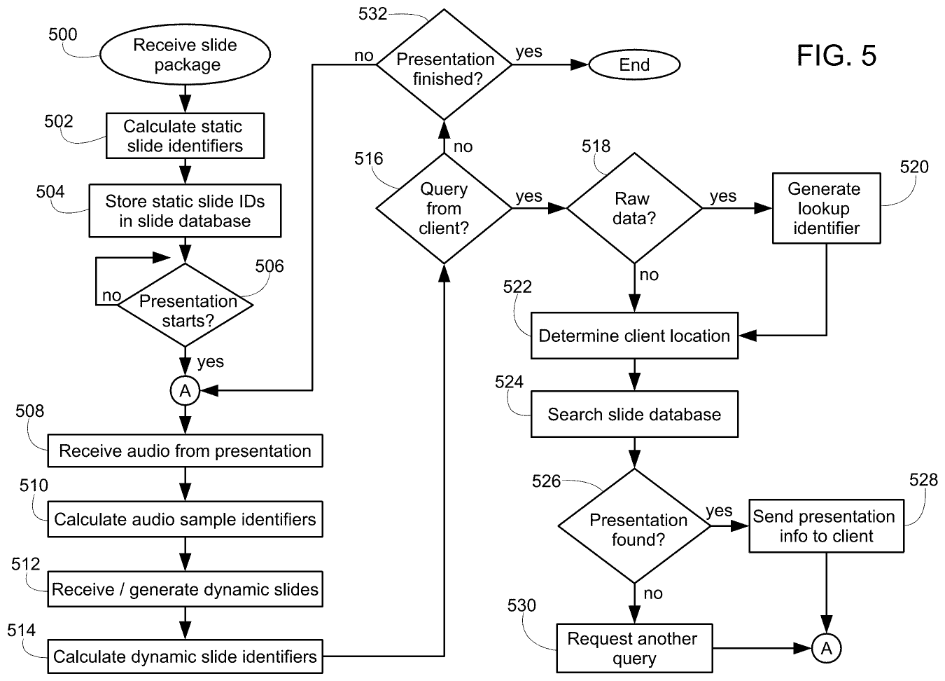

FIG. 5 shows a flowchart of a method of automatically logging in an attendee device 108 to an ongoing presentation according to an exemplary embodiment. The steps of FIG. 5 may be performed by one or more processor(s) of the control server 102 such as by executing software instructions loaded from the storage device 124 or another storage medium. The steps of the flowchart are not restricted to the exact order shown, and, in other configurations, shown steps may be omitted or other intermediate steps added.

The method starts at step 500 with the receipt of a slide deck package from the presenter device 112. The control server 102 may receive the slide package from the presenter at any time prior to the presentation start time.

At step 502, the control server 102 determines a slide identifier for each static slide in the slide package. Static slides are slides that have only fixed content such as images, charts, text, or even video or audio that does not depend on audience participation or sensor data during the presentation. For static slides, step 502 may involve the control server 102 computing a respective slide code for each as illustrated in a single column of the table in FIG. 4. As previously explained, the actual computation of the slide code can utilize any desired algorithm such as known image recognition and processing, whether performed by the control server 102 itself or one or more separate devices such as an external image processor 122 or even assistance from the presenter device 112 itself If the slide package is for a new presentation, other details such to set up the new presentation such as assigning a unique identifier for the presentation and notifying pre-registered attendees may also be performed at this step as well. The slide identifier generated at this step may correspond to any characteristic or signature for the slide and does not require the presenter to put any specific information on the slides in advance. Beneficially, the slide identifiers are determined based on whatever content is desired to be on the slide as chosen and designed by the presenter.

At step 504, the control server 102 stores the static slide identifiers in a slide database. For instance, this step may involve storing or adding a code column to the table illustrated in FIG. 4 for storage in the storage device 124.

At step 506, the control server 102 waits for the presentation start time to be reached. Of course, if an updated slide package is received from the presenter device 112, control can also return back to step 500 to restart the process and update the slide identifiers for the new or changed slides. When the start time is reached control proceeds to step 508.

At step 508, the control server 102 receives audio from the ongoing presentation. For instance, audio captured by the microphone 118 on the presenter device 112 may be streamed in substantially real time back to the control server 102 over the wide area network. Alternatively, the audio may come to the control server 102 from another source such as from an attendee device 108 already associated with the presentation and in attendance at the presentation, a public address system, or any other audio device at the presentation.

At step 510, the control server 102 calculates audio sample codes for the received audio. Audio sample codes are similar to the above-described image codes but are for sections of audio rather than for graphical images. For instance, each five second block of audio may be sampled with a voice-to-text algorithm to generate text representing the words being spoken at that moment by the presenter. Likewise, audio processing and hashing algorithms may be applied by the control server 102 and/or the presenter device 112 and/or attendee device 108(s) in order to determine an identifier that represents that section of audio. These audio sample identifiers are stored in the storage device 124 in a column under the presentation similar to the slide codes shown in FIG. 4.

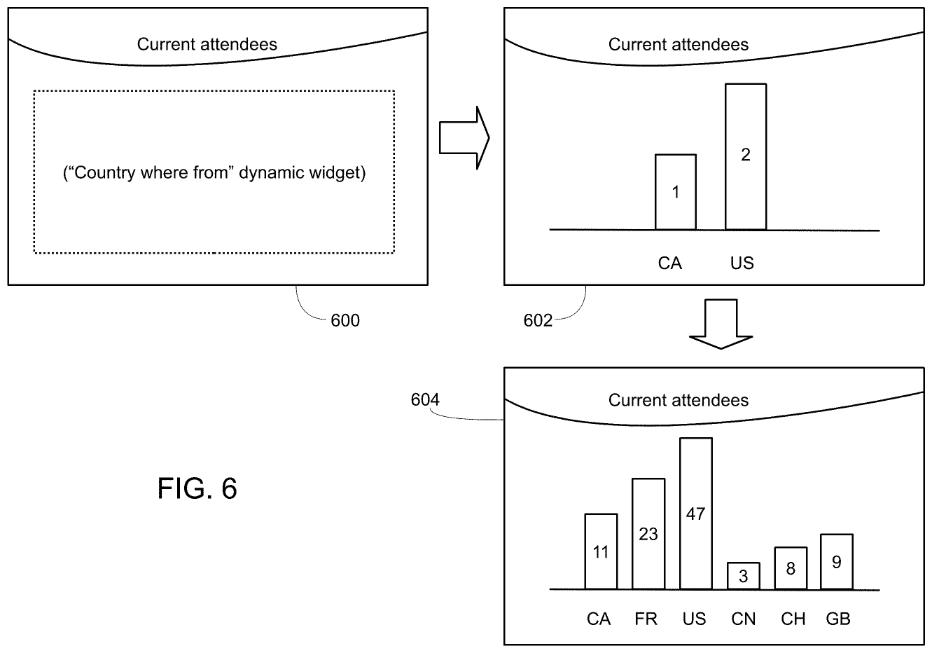

At step 512, the control server 102 receives and or generates any dynamic slides presented during the presentation. For instance, dynamic slides may display content that changes at the time of the presentation according to audience participation and therefore cannot be known in advance of the presentation. For instance, as shown below, slides showing questions from the audience as entered by pressing the ask a question button on UI screen of FIG. 2 or live statistics about the audience members (described further below in reference to FIG. 6, for example).

At step 514, the control server 102 generates dynamic slide codes for the dynamic slides. For instance, as dynamic slides change over time, the control server 102 may utilize the same techniques previously descried for step 502 to generate slide codes. A single dynamic slide may have a plurality of different identifiers that correspond to the dynamic slide at different points of time. The same thing applies to video slides that may change in advance; however, video clips are known in advance so the control server 102 can compute the slide identifiers for the video clip in advance at step 504. For dynamic slides depending on audience participation, the content is only known during the presentation and therefore is calculated substantially in real time at step 514.

At step 516, the control server 102 determines whether a query from an attendee device 108 has been received. The query received at this step is from an attendee device 108 that is not currently associated with any presentation but wishes to join a presentation according to a captured data sample. The query is sent by the attendee device 108 after capturing a data sample such as image and/or audio using UI screen shown on the left-hand side of FIG. 2. When a query has been received, control proceeds to step 518; alternatively, control proceeds to step 532.

At step 518, the control server 102 determines whether the query includes raw data. Raw data in this context refers to an image, video, or audio clip. In this case, further processing is required by the control server 102 in order to determine a slide identifier that corresponds to the raw data and control proceeds to step 520. Alternatively, if the query includes one or more slide and/or audio identifiers rather than the raw data, control proceeds to step 522.

At step 520, the control server 102 generates a lookup identifier based on the raw data sample. For image/video samples, the lookup identifier may be computed similar to a slide identifier at step 502. For audio samples, the lookup identifier may be computed similar to an audio identifier at step 510. In some embodiments, both an image and an audio sample are received at step 516 and therefore at step 520 both types if lookup identifiers are generated.

At step 522, the control server 102 determines a location of the attendee device 108. The location information may be determined by a plurality of techniques including receiving global positioning system (GPS) coordinates from the attendee device 108 such as within the query at step 516. However, GPS coordinates are not the only way to determine the location. The source IP address of the query received at step 516 may also identify the location. Pools of different addresses may be assigned on different local area networks (LANs 110) at different venues and therefore the source address from which the query is received may identify the conference centre itself. This is particular beneficial when the control server 102 handles presentations for multiple conference centers. Geo-fencing may also be utilized to benefit the event organizer by limiting only attendee devices 108 physically present to have access to the content.

At step 524, the control server 102 searches the slide database in the storage device 124 utilizing the lookup identifier(s) and/or client location information to determine the associated presentation. Taking the slide database illustrated in FIG. 4 as an example, if a lookup identifier of the query of step 516 is “88C648” then the control server 102 will determine the attendee device 108 from which the query was received to be associated with presentation A. Alternatively, if the lookup identifier of the query of step 516 is “8FA603” then the control server 102 will determine the attendee device 108 from which the query was received to be associated with presentation B.

The data samples or identifiers received within the query can also be utilized in combination with each other at this step. For instance, in the case of duplicate slides in different presentations, although the slide lookup identifier may be the same, the audio will likely be different in the two different presentations and therefore the audio lookup identifier allows the control server 102 to distinguish between the two presentations that happen to have a same slide. Thus, the image lookup identifier received at step 516 (or generated at step 520) can be utilized in combination with an audio lookup identifier received at step 516 (or generated at step 520).

At step 526, the control server 102 determines whether a presentation was found associated with the lookup identifier(s) received or otherwise generated for the query of step 516. When yes, control proceeds to step 528; otherwise, control goes to step 530.

At step 528, the control server 102 performs all the necessary steps to log the attendee device 108 from which the query was received into the presentation found associated with the lookup identifier received in the query. This step may include a number of known sub steps not expressly shown herein such as adding an identifier such as MAC/IP address of the attendee device 108 to a list of devices associated with the presentation and sending information related to the presentation to the attendee device 108. Information sent to the attendee device 108 may include an electronic copy of the slide deck or information required for the attendee device 108 to generate the slide deck locally. Likewise, bidirectional communication between the attendee device 108 and the control server 102 can take place at this point such as to update dynamic slides for display on the attendee device 108 and to receive questions or other interactions entered into the UI screen on the attendee device 108.

At step 530, because the control server 102 cannot identify the presentation from the information included in the query, the control server 102 requests another query be sent. For instance, if the attendee device 108 takes a picture of a blank sheet of paper and does not provide an audio sample, the control server 102 will not be able to determine the associated presentation and will need more information in order to perform automatic log in.

At step 532, the control server 102 determines whether the presentation is finished. If no, control returns back to step 508 to keep updating the various slide and audio identifiers and to keep logging in any new attendee devices 108 during the ongoing presentation using the above-described steps. On the other hand, if the presentation is over, the control server 102 may disable automatic log in functionality and the process ends.

In an exemplary embodiment, attendees use the above-described automatic live visual recognition of slides feature to automatically log in to or otherwise join the presentation. The user first opens the conference's webapp or mobile app and uses the webapp or app to take a photo of the big screen or take a picture of what their neighbour is viewing on another attendee device (anywhere the slide is being displayed will also work such as monitors hanging in the lobby or televisions, for example). A recognition engine such as running software on the control server 102 scans the image and determines characteristics and then searches an internal database to determine the session/presentation associated therewith. The recognition engine may be performed by the control server 102, the attendee device 108, and/or a combination thereof in different embodiments. Once finding a matching session for the received image, the control server 102 sends the matching session information to the attendee device 108 and the audience application has the information for the user to enter the presentation on their mobile device 108.

Low quality/resolution of the photo or other data sample may reduce the chance to connect to the correct session or may lead to connecting to an incorrect session. To overcome this issue, checks are put in place for the control server 102 to correlate GPS location with the location where the slide is shared from. Comparison with sound recognition technology results may also be performed to ensure the picture was taken in the same room 302 as determined based on the image. Likewise, the sound from the attendee's mobile device 108 and the sound of the room 302 recorded by the presenter's device 112 may also be utilized to ensure the detected session is the correct session and matches the ambient audio around the attendee's mobile device 108. Other techniques for confirming the detected session is the correct session may be used in other embodiments including Bluetooth beacons, audio beacons, SSID values, network addresses, etc.

FIG. 6 illustrates a sequence of UI screens for setting up and displaying a dynamic slide showing live audience statistics according to an exemplary embodiment. Dynamic slides are slides that incorporate content that dependent upon the audience members or other events that occur during the presentation itself. Assuming attendee devices 108 only login as the event is starting, the content of dynamic slides cannot be known in advance of the presentation. However, the content of the dynamic slides is known to the presenter before the presentation start as long as the attendee devices 108 are logging into the platform before the presentation starts. The dynamic slides get populated with live content as soon as new users are logged in, but the slides are not yet shared to the audience. This means that the presenter can already see the dynamic slides being populated before sharing occurs. It could be five minutes before the event starts but could also be one month before assuming the presenter shared the login URL or other links and motivated the attendees to login.

In some embodiments, the presenter uses an add-on to a presentation program such as Microsoft® PowerPoint or Apple® Keynote to define and add ‘Live Audience Statistics Slides’ into their presentation. These dynamic slides are frame slides containing one or several customizable empty charts. The charts will have live data injected into them by the control server 102 as attendees start to log in to the presentation session. The dynamic slides display simple and/or complex charts visualizing the audience data and various statistics in the way the presenter has defined. Of course, besides presentation software using slides, other types of applications such as photo database software may also be utilized to define live audience dynamic slides.

A first level of data generates live demographics charts, which are the treatment of social media data provided by attendees when they log in, and data that attendee devices 108 provide to the control server 102 if they use the login engine provided by the control server 102. A second level of data generates live participation charts, which represent engagement and actions performed by the attendees utilizing various functions of the presentation app/web app running or displayed on the attendee's device during the ongoing presentation at the conference. The various charts change in substantially real-time (live changes), as people connect and interact prior to, during, and if desired even after the presentation. Dynamic slides are also extendable and may be automated to give away prizes and swag to attendees for completing certain actions such as completing a survey, tweeting a slide, asking a question, making a comment, liking a slide, etc.

A first UI screen 600 shown in FIG. 6 illustrates the presenter setting up a dynamic slide while creating their slide deck before the presentation has started. In this example, the presenter selects a “country where from” dynamic widget and sizes the widget frame as desired on the slide. In addition, this slide creation can also be done live while the presentation is happening. The data are pulled automatically as soon as the slide is generated, the pulled data are for all participants, even people logged in before the creation of that dynamic slide.

A second UI screen 602 shown in FIG. 6 illustrates the output of the dynamic slide as displayed on the projector 304 or other display device 114 to attendees at the beginning of the presentation. At this point in time, there are not very many attendees (only three attendees) but data from each of the attendees regarding country of origin is automatically displayed. As more and more attendees log in to the presentation, either manually logging in or utilizing the automatic log in process previously described in the method of FIG. 5, the control server 102 can lookup the country of origin associated with those newly logged in users and dynamically update the slide accordingly. The newly updated dynamic slide or data allowing formation thereof is sent to both the presenter for display to the audience and also to the various attendee devices 108 that are logged in to the event. For instance, updates may be sent by the control server 102 as soon as the control server 102 detects a newly logged in device at step 528. In some embodiments, the control server 102 sends a batch update periodically such as once every minute.

A third UI screen 606 shown in FIG. 6 illustrates the situation after the presentation has started and many attendee devices 108 have logged in. At this point in time, there are a total of one-hundred and one attendees in the audience who have logged in to the presentation. The various attendees are grouped into the appropriate countries of origin.

This or other dynamic slides may be displayed to the presenter at all time or at certain times during the presentation or may be available for quick reference to the presenter without display to the audience as a part of the slide deck. The presenter may choose whether and when to display the dynamic slide the audience. For instance, the presenter may have a repertoire of potentially interesting dynamic slides based on live audience statistics in reserve to utilize if required or desired during the presentation. Customizable alarms and thresholds may be sent in order to notify or flag the presenter via the presenter device 112 if certain conditions are met. During the presentation, the presenter device 112 may let the presenter know when alerts/thresholds are triggered by live audience member statistics and the presenter may decide to spontaneously flip to one of the dynamic slides if it is relevant to the presentation. Because the dynamic slides are triggered from events that occur during the presentation and in particular may be triggered from actions and statistics of the audience members themselves, the live statistic dynamic slides tend to increase audience attention and engagement. Dynamic slides showing live statistics during the presentation are a beneficial technique for presenters to prevent the “death by PowerPoint” phenomenon.

Like regular slides, whether dynamic slides are provided to the logged-in attendee devices 108 for storage as a part of the regular slide deck can be a user configurable setting. In some cases, the presenter may decide to send the slides to the attendees and in others their dynamic nature may be more applicable in the moment and there is no need or desire to send these slides to the logged in attendee devices 108.

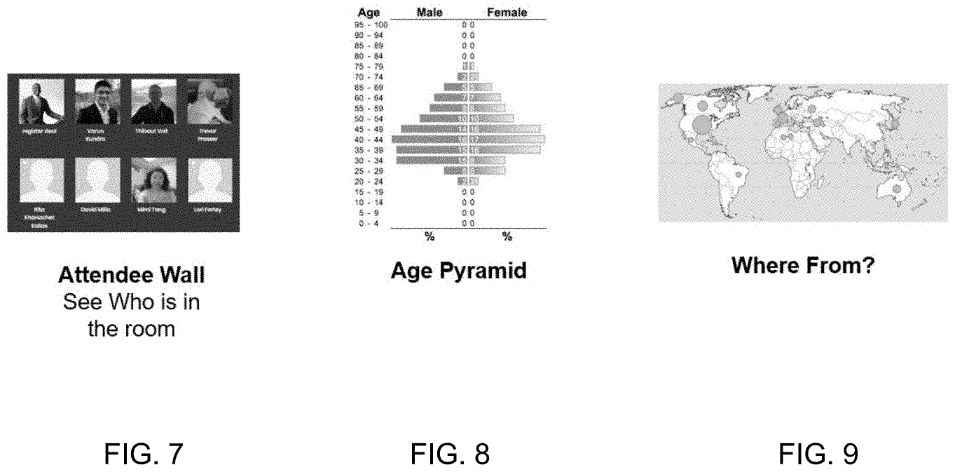

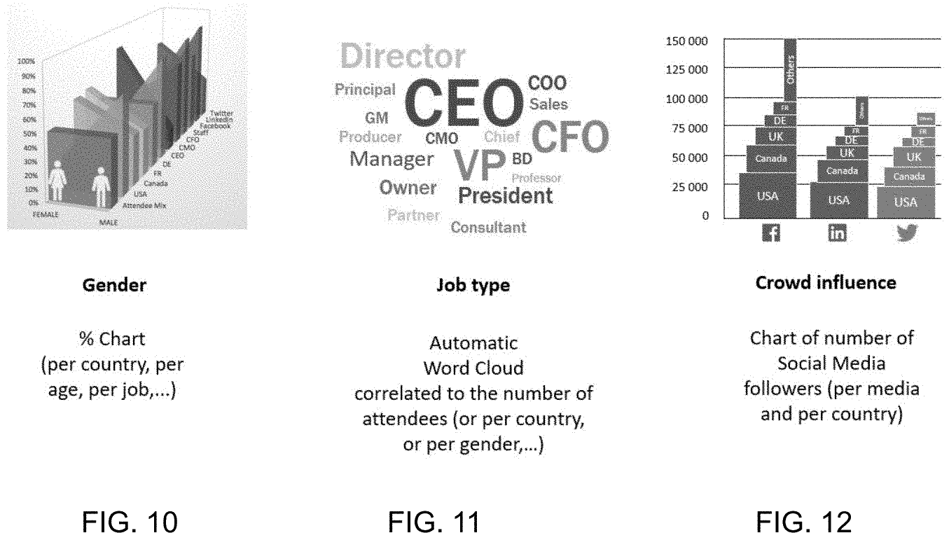

FIGS. 7 to 12 show various examples of dynamic slides that are based on attendee information. In particular, FIG. 7 illustrates a live attendee wall that shows the names and social media profile picture for each currently logged in attendee. The order may be listed in order to log in so that newly logged in attendees pop up on the bottom or the top and the wall scrolls as more and more attendees join. FIG. 8 illustrates an age pyramid of the attendees logged in to the event. FIG. 9 illustrates another form of a “where from” widget that shows the origin locations for each logged-in attendee on a world map. FIG. 10 illustrates a gender graph with different colors showing categories for each gender of logged in attendee. FIG. 11 shows a word cloud of the various job titles and types of the logged-in attendees during the presentation. FIG. 12 illustrates a crowd influence chart showing the number of various social media site followers and users currently logged in to the presentation. As described above, each of the above examples will dynamically change as the attendees log in and out of the presentation.

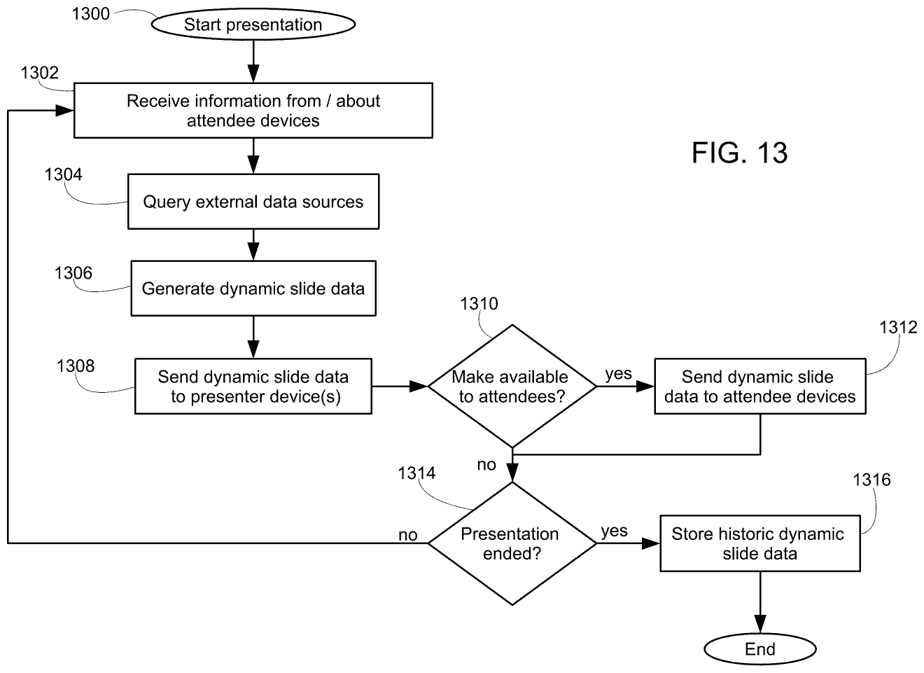

FIG. 13 shows a flowchart of a method of generating and updating dynamic slides based on external events during the presentation according to an exemplary embodiment. The steps of FIG. 13 may be performed by one or more processor(s) of the control server 102 such as by executing software instructions loaded from the storage device 124 or another storage medium. The steps of the flowchart are not restricted to the exact order shown, and, in other configurations, shown steps may be omitted or other intermediate steps added.

In this embodiment, the method starts at step 1300 when the presentation starts.

At step 1302, the control server 102 receives information from attendee devices 108. The information received at this step may be the fact that a new attendee device 108 has been logged in at step 528 of FIG. 5. However, even after login has occurred, other information may also be received from the logged-in attendee device 108. The attendee device 108 may send to the control server 102 a user identifier such as an email address, name, phone number, company name, attendee number, social media account identifier, or any other information about the user or the attendee device 108. Likewise, information about actions taken by the user such as interactions with the UI screen illustrated in FIG. 2 may also be sent by the attendee device 108 and received by the control server 102 at step 1302. For instance, each time the attendee device 108 is used to take notes or to ask a question or to send a message etc., information may be sent from the attendee device 108 to the control server 102. Likewise, the information received at step 1302 may be about the fact that an attendee device 108 has logged out or otherwise left the presentation such as being unreachable or out of communication with the control server 102.

At step 1304, the control server 102 queries one or more external data sources to lookup any required information about the user of the attendee device 108. In one example, the information received at step 1302 may include a social media account identifier such as a URL of a profile of the attendee. The control server 102 then at step 1304 queries the social media platform to access the profile of the attendee. Various information about the attendee can then be extracted from the profile such as age, occupation, title, country, etc.

At step 1306, the control server 102 generates dynamic slide data according to the information received at step 1302 and/or the information retrieved from the external data sources at step 1304. For instance, if one of the dynamic slides desired by the presenter is the “country where from” slide shown in FIG. 6, the country field located on the user's social media profile may be read and then the appropriate data in the dynamic slide is updated accordingly. If the user's social media platform indicates a country of France, the “FR” column is incremented.

At step 1308, the control server 102 sends the dynamic slide data to the presenter device(s) 112. In some cases, the presenter may have multiple devices 112 such as a primary laptop utilized to control the slide deck along with a portable device for providing feedback and information to the presenter that is not usually directly seen by the audience members. A heads-up display, portable phone, or second screen are examples of secondary presenter devices 112. In some embodiments, dynamic slides with live audience statistics are displayed to the presenter on secondary presenter devices 112 as an available option for the presenter to utilize if it makes sense during the presentation. A button or other UI element on the secondary presenter device 112 may allow the presenter to select any of the dynamic slides for presentation and/or deliver to the audience via the logged in attendee devices 108.

At step 1310, the control server 102 determines whether the dynamic slide is to be made available to the audience members. If yes, control proceeds to step 1312; otherwise, control proceeds to step 1310.

At step 1312, the control server 102 sends the dynamic slide data to the logged in attendee devices 108 thereby allowing these devices to display and/or update the dynamic slide for local viewing by users directly on their attendee devices 108.

At step 1314, the control server 102 determines whether the presentation has ended. If yes, control proceeds to step 1316; otherwise, control returns to step 1302 to repeat the above process to keep updating the dynamic slides according to information from/about the attendee devices 108 and their respective users logged in to the presentation.

At step 1316, the control server 102 stores historic dynamic slide data for future reference. The dynamic slide data changes over time during the presentation and it may be beneficial to analyse this data and/or recreate the dynamic slide after the presentation is over. For this reason, the control server 102 may save the data and make it available to the presenter (and if desired also to the attendee devices 108) for later analysis.

It should be noted that in some embodiments, there is a difference between a “Presentation End” and a “Session being stopped”. This means that even if the presentation has ended (i.e., the presenter has finished and is no longer on stage), the session can still go on and new attendee devices 108 can still log-on, comment, chat, and therefore the live slides (i.e., the ones showing the LIVE data/stats) are still being amended (in the cloud by the control server 102). Only once the presenter stops the session are the LIVE slides locked down and consequently available for download by the audience. Prior to this stop, the LIVE slides which are downloaded would have a placeholder visual.

The method of FIG. 13 changes the way a presenter can engage with the audience. The graphs show to each individual a high-level snapshot of the group they are in (i.e., the audience) at the moment of the live in-person event. This is like a live group mirror shown to each individual, depicting who is the audience, what they did during the conference, and triggers a self-reflection by each individual on where they fit in that group picture. Seeing the live data being updated on the big screen is a motivation to contribute, for the attendees who have not yet joined in. The level of attention and engagement will reach its highest level as the presenter demonstrates who they are as a group and talks about what may very well interest the audience the most: themselves.

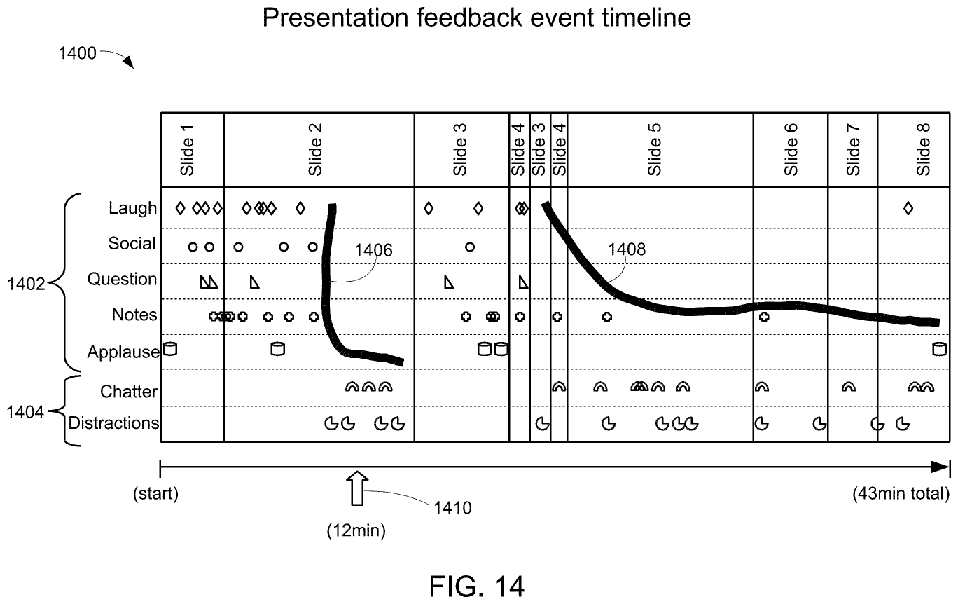

FIG. 14 illustrates a feedback UI screen 1400 showing an event timeline to the presenter regarding a presentation according to an exemplary embodiment. The feedback UI screen may be shown to the presenter as a dynamic slide during the presentation such as on a secondary presenter device 112, for example. It may even be utilized as a way to re-engage the audience during a live presentation. However, in many applications, the feedback UI screen 1400 is something that is utilized by the presenter only after the presentation is over.

The feedback UI screen 1400 illustrates the time line of the presentation flowing horizontally left to right. The slide that was being displayed is indicated at the top and the occurrence of various events is tracked underneath the slide at the times that they occurred. For instance, various audience engagement feedback items and sentiments are tracked and displayed in this example including laughs, social media posts, questions, notes, applause, chatter, and distractions. The first five items 1402 in this example constitute positive engagement items and a goal of a presenter may be to increase activity in these categories. The last two items 1404 in this example constitute negative engagement items and a simultaneous goal may be to minimize activity in these categories.

The control server 102 may receive information from a plurality of sources in order to track these items and when they occurred. For instance, the laughs may be tracked by the microphone 118 on the presenter device 112 and/or attendee devices 108 during the presentation. In many embodiments, the entire audio of the presenter is captured by the presenter device 112; however, the ambient noise within the room may also be recorded in a similar manner using other microphones 118. With the consent of the attendees, the attendee devices 108 of logged in users may be leveraged to capture and/or analyse the ambient sound. Likewise, other microphones 118 may be distributed at various locations around the crowd by the venue prior to the start of the presentation. Audio captured may be processed onsite such as by the presenter device 112 in order to detect laughs, and laugh occurrences sent to the control server 102 via the LAN 110 and WAN 104 networks.

The social media posts may be tracked by the control server 102 monitoring social media sites 120 for known hash tags or keywords or even individual attendees logged in or otherwise associated with the presentation.

The questions may be received by the control server 102 as a part of live audience engagement using the UI screen of FIG. 2 after logging in to the presentation—see the ask a question button. Same with the notes item—see the notes button.

Applause and general audience chatter and noise may be tracked in a similar manner as laughs described above. Finally, distractions may be defined as occurring when a logged in user switches out of the UI screen in order to perform other tasks using their mobile attendee device 108 such as to send emails or surf the web.

The first feedback UI screen may also display general trend lines that show negative or positive trends detected by the control server 102 or presenter device 112 according to the data captured for the various feedback items. As illustrated in FIG. 14, there are two general trend lines 1406, 1408 that occur in the negative direction. The first trend line 1404 occurs during the second slide, which started off strong and then ran out of steam where chatter and distractions started occurring before the presenter finally switched to the third slide. Once that happened, the positive feedback items came back. The second negative trend line 1408 started when the presenter returned back to the third slide for a second time. There was generally no recovery after this point with only a few notes being taken and then some laughs and applause right at the end of the 43 min presentation.

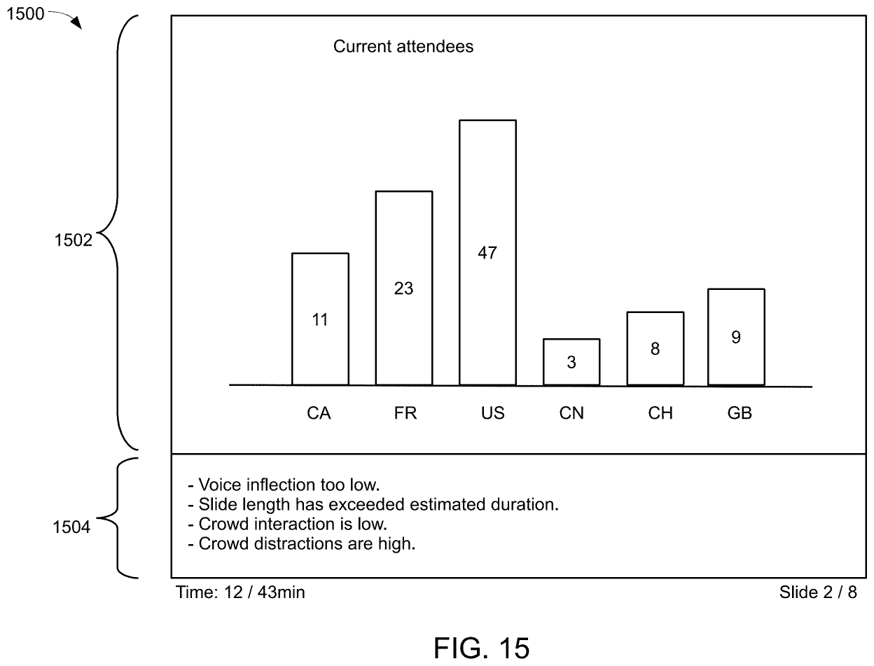

FIG. 15 illustrates a second feedback UI screen 1500 that plays a recording of the presentation in a playback area 1502 to the presenter along with subtitles providing comments and tips in a tip area 1504 to improve the presentation in the future. The second feedback UI screen 1500 may be shown simultaneously with the time line 1400 in FIG. 14. In this embodiment, the timeline pointer 1410 is a moveable UI element allowing the presenter to jump around the presentation and to start playback at various points in time. While the recording plays in FIG. 15, the pointer 1410 on FIG. 14 moves to the right according to the elapsed time. In addition to the slides of the presentation as shown to the audience, the playback area 1502 may play any type of media including video/audio recording, podcast, website, or a rich-text document (e.g., .doc or .pdf file for instance) containing images, sound, etc.

The tips shown in the tip area 1504 in FIG. 15 are based on the tracked feedback items and history thereof. They may also take into account the history of the presenter themselves and note improvements on the presentation compared to previous deliveries. The slides as presented to the audience are shown in the main window and the audio from the presenter and/or ambient audio may also be provided during playback.

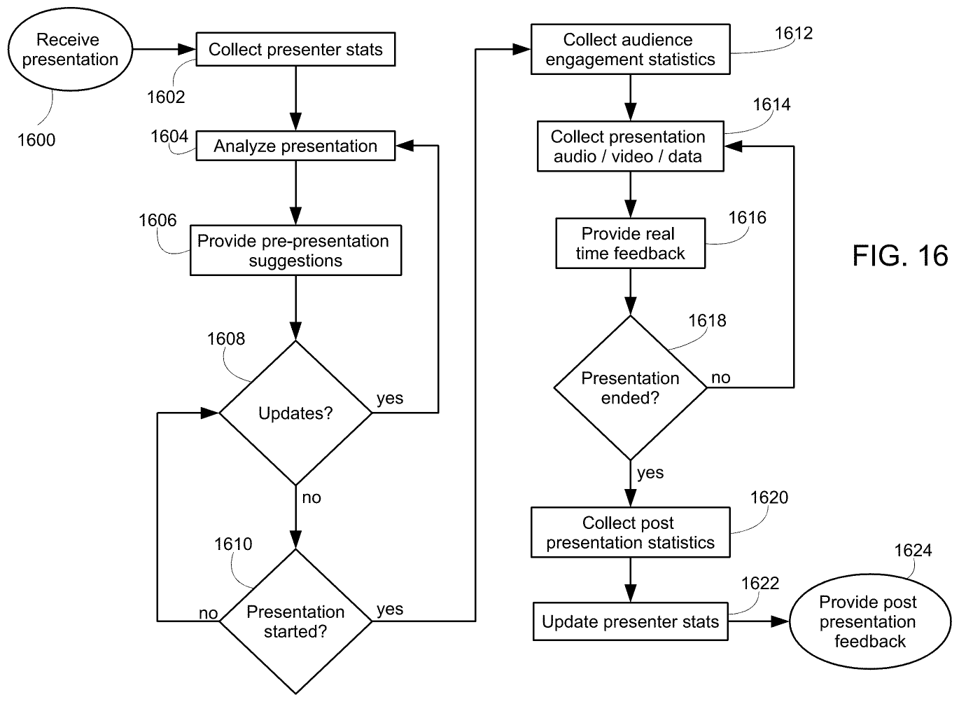

FIG. 16 shows a flowchart of a method of providing presenter evaluation and feedback according to an exemplary embodiment. The steps of FIG. 16 may be performed by one or more processor(s) of the control server 102 such as by executing software instructions loaded from the storage device 124 or another storage medium. The steps of the flowchart are not restricted to the exact order shown, and, in other configurations, shown steps may be omitted or other intermediate steps added.

The method starts at step 1600 when the control server 102 receives the presentation slide deck or data thereof from the presenter device 112 prior to the presentation starting. Step 1600 may correspond to step 500 in FIG. 5.

At step 1602, the control server 102 retrieves the presenter's historic statistics stored in the storage device 124. These stats may include historic presentation details and engagement feedback items tracked for previous presentations done by the presenter. Likewise, general tracked data may also be loaded at this step for other presenters to use as a reference point.

At step 1604, the control server 102 analyses the slide deck according to the historic data. The slide deck may include both slides, content, text transcript, and even recorded audio and video of practice runs through the presentation by the presenter.

At step 1606, the control server 102 provides the presenter with pre-presentation suggestions according to the analysis performed at step 1604. The pre-presentation suggestions may involve comments and suggestions based on the previous time the presenter did the presentation before a live audience. The suggestions may also include tips based on the slide deck along with historic events. For example, based on historic data about the presenter's speed of speaking, the control server 102 may determine that a particular slide deck has too few or too many total slides in comparison with the presentation time and/or projected transcript. Likewise, individual slides may be analysed such as to detect too much text on the slide, too small fonts, general business, etc.

At step 1608, the control server 102 determines whether there have been any updates to the slide deck by the presenter. If yes, control returns to step 1604 to repeat the analysis based on the changed content. Otherwise, control proceeds to step 1610.

At step 1610, the control server 102 determines whether the presentation has started. If yes, control proceeds to step 1612; otherwise, control returns to step 1608 to check for last minute changes to the slide deck.

At step 1612, the control server 102 collects audience engagement statistics. Step 1612 may involve the control server 102 receiving data from the both the attendee devices 108 or other external devices. For instance, step 1612 may include tracking some of the feedback items collected for live dynamic slides collected at steps 1302 and 1304 in FIG. 13.

At step 1614, the control server 102 collects presentation audio/video. The video may be video of the presenter performing the presentation taken from a camera 116 that points to the stage or may be collected from the camera 116 on the presenter device 112 itself. Alternatively, in some embodiments, the slide information may simply be recorded at the control server 102 in the historic data without actually taking video of the presenter. Collecting audio and other data of the presenter during the presentation may also correspond to step 508 of FIG. 5.

At step 1616, the control server 102 presents real time feedback to the presenter. Real time feedback may be displayed similar to a dynamic slide on a secondary screen seen only by the presenter and may include any of the above tips or graphs shown in FIG. 14 and FIG. 15, for example.

At step 1618, the control server 102 determines whether the presentation is finished. If no, control returns to step 1614 to continue collecting presentation audio/video and other data. Otherwise, if finished, control proceeds to step 1620.

At step 1620, the control server 102 collects post presentation statistics such as the time of feedback events in FIG. 14 and saves them in the storage device 124 for the presenter.

At step 1622, the control server 102 updates the presenter statistics. In some embodiments, the presenters in the system may agree to have their statistics publicly available in order to attract new speaking opportunities. For instance, a presenter that generates many laughs may be desirable for a keynote positions at a particular conference. Having open statistics for presenters based on objective data collected by and stored at the control server 102 may be beneficial both to conference organizers and presenters.

At step 1624, the control server 102 provides post presentation feedback and tips to the presenter. For example, the timeline and movie playback with tips illustrated in FIG. 13 and FIG. 14 allow the presenter to learn and self improve after each presentation.

Exemplary benefits of the embodiment of FIG. 16 include providing evaluation of the presentation/event, feedback and recommendations to make the next presentation/event better. The various feedback and tips enhance the value delivered by control server 102 and system of FIG. 1 to both presenters and event organizers. Transparency is increased, feedback on quality of presentations is provided, and recommendations and tips/guidelines are provided showing actionable ways presenters can improve engagement and highlight characteristic that drive engagement at events.

The system 100 beneficially captures participating attendee's interaction with presentation content as well as other attendees at the event. It uses captured and computed metrics (using custom algorithms, data-analysis, machine learning and/or artificial intelligence on information captured such as audio, video and ambient sound at an event as well as activities on influential social media sites 120) to co-relate actions to a timestamp and slide within a presentation. For example, presenter's content including slides, resources, links, and slide interactions e.g. rate at which the slides are advancing in the slide deck. Attendees activities may also be tracked including liked slides, slides shared on social media, questions, comments, moments of notes taking, polls participation level, which docs have been viewed or downloaded and more. Audio recording from the room including presenter voice and audience reactions are captured and feedback is provided to the presenter either during and/or after the presentation.

In some embodiments, the control server 102 computes an engagement score for each slide based on tracked and computed metrics. All these activities are time-stamped and therefore a level of engagement per slide can be calculated and compared between slides. The control server 102 can also create a ‘graph curve’/a grade and Math formula (f(x)= . . . ). This is similar to the trend lines 1402, 1404 shown above in FIG. 14.

The control server 102 can also correlate information such as how many slides were reviewed, shared, commented on. The correlation of this data, combined with a qualitative analysis of the voice recording (tone, speed . . . ) allows the control server 102 to output an engagement level timeline, with ups and down, which is the base for defining the improvement criteria.

As illustrated in FIG. 15, the output can also be summarized as a video recording (i.e., a Moving Picture Experts Group, MPEG file) highlighting the great and/or improvable moments with an automatically generated spoken voice over text.

The output can also be generated by the control server 102 as a visual (infographics) or a dynamic HTML/web-based timeline.

Concerning the database of speakers, this enables new ways to compare presenters/speakers based on engagement. The presenter database stored in the storage device 124 at the control server 102 enables event organizers to find presenters based on desired metrics such as speakers who generated the most laughter at their presentations. The control server 102 can analyze presentations that have a particular metric such as a minimum level of engagement per slide ‘graph curve’/a grade or math formula (f(x)= . . . ), to create a reference database of the most engaging presentations, and therefore a reference for success and best practices.

The control server 102 captures information from the presenter, the attendee interactions and the environment and can therefore make correlations that were previously not possible. The control server 102 is also able to tie user behavior to their opinions more granularly. That is, merging quantitative and qualitative data sources to output improvement recommendations for a presentation as is disclosed above is beneficially closer to a human performance relying on a personal talent, than a pragmatic analytical task.

Each of the above-described devices such as the control server 102, presenter device 112, and attendee device 108 may include one or more processors. The one or more processors may be included in a central processor unit (CPU) of a computer server or mobile computing device acting as each these devices. In this description the plural form of the word “processors” has generally been utilized as it is common for a CPU of a computer server or mobile computing device to have multiple processors (sometimes also referred to as cores); however, it is to be understood that a single processor may also be configured by executing software loaded from a memory to perform the described functionality in other implementations.

In an advantageous embodiment, a presentation system includes a control server 102 coupled to a presenter device 112 via a network. The control server 102 receives a slide deck from the presenter device 112 and calculates a plurality of slide identifiers and analyses the slide deck to provide pre-presentation tips to the presenter. Attendee devices 108 may log in to the presentation in order to receive a copy of the slide deck and to interact with the presenter and other attendees. In automatic log in, an attendee device 108 is utilized to take a picture of a current slide or sample audio of the ongoing presentation. A slide recognition engine on either or both of the attendee device 108 or the control server 102 matches the data from the attendee device 108 to a slide database to determine the presentation session and automatically log in the attendee. During the presentation, the control server 102 automatically populates dynamic slides based on statistics from the audience including engagement and feedback items. After the presentation is over, the control server 102 generates and sends feedback to the presenter.

Although the invention has been described in connection with preferred embodiments, it should be understood that various modifications, additions and alterations may be made to the invention by one skilled in the art without departing from the spirit and scope of the invention. For example, rather than the control server 102 always calculating slide identifiers in steps 502 and 514, the slide identifiers for a new presentation and/or dynamic slides newly updated can also be computed by the presenter device 112 and then sent to control server 102, again reducing the load on the control server 102.

Any of the above-described features may be used separately or in combination with each other. For instance, each of A) the automatic log in feature described generally in FIGS. 1-5, B) the dynamic slides feature described generally in FIGS. 6-13, and C) the presentation evaluation and feedback feature described generally in FIGS. 14-16 may be utilized separately and independently in different embodiments. Likewise, they may be combined and utilized in a single system that incorporates all three features. In some embodiments, whether one of these features is activated may be dependent on payment choices by a user such as the presenter or conference provider. As such, the features may be user configurable options and their usage may require payment to a provider of the system 100.

Although the above-description has focused on presentations and logging in to events such as in-person speaking events, the same techniques and technology may also be applied in other applications such as any group session including work groups and internal business collaboration. The attendees and presenters and their respective devices 112, 108 may switch roles at any time during the event. It is also not required that the event have a shared projector screen or other media device 114; instead, the above-described techniques are equally applicable to facilitating automatic session login and/or joining by a new attendee simply capturing an image (or sound) from another attendee's screen. This is illustrated for example in FIG. 3 room “C” and may also be utilized in online group meetings where a new person such a coworker wishes to join an online meeting between colleagues. The new person may simply take a picture of the screen materials of their coworker's attendee device 110 to join the group. Likewise, the same techniques can be applied using photos from a camera roll and may also be applied in non-professional settings.

The above-described functions of the control server 102 may be partitioned across a plurality of different servers both on the WAN 104 and/or LAN 110. The presenter device 112 and attendee device 108 may also incorporate software modules and applications in order to take over and perform all or some of the above-described functions of the control server 102 in other embodiments. Likewise, although the above-description has focused on slides of a presentation, any content that is to be discussed or referred to or shown to a group may also take the place of the slides. For instance, steps 502 and 514 may be modified to calculate other types of content identifiers. In addition to slides, other examples of content that may be presented to a group and for which a content identifier (instead of a slide identifier) can be computed include images, videos, text documents, screenshots, screensharing, etc.

The above described functionality and flowcharts may be implemented by software executed by one or more processors operating pursuant to instructions stored on a tangible computer-readable medium such as a storage device 124. Examples of the tangible computer-readable medium include optical media (e.g., CD-ROM, DVD discs), magnetic media (e.g., hard drives, diskettes), and other electronically readable media such as flash storage devices and memory devices (e.g., RAM, ROM). The computer-readable medium may be local to the computer executing the instructions, or may be remote to this computer such as when coupled to the computer via a computer network such as the Internet. The processors may be included in a general-purpose or specific-purpose computer that becomes the control server 102, presenter device 112, attendee device 108 or any of the above-described devices as a result of executing the instructions.

In other embodiments, rather than being software modules executed by one or more processors, the functionality may be implemented by hardware modules configured to perform the above-described functions. Examples of hardware modules include combinations of logic gates, integrated circuits, field programmable gate arrays, and application specific integrated circuits, and other analog and digital circuit designs.

Functions of single devices described above may be separated into multiple units, or the functions of multiple units may be combined into a single device. Unless otherwise specified, features described may be implemented in hardware or software according to different design requirements. In addition to a dedicated physical computing device, the word “server” may also mean a service daemon on a single computer, virtual computer, or shared physical computer or computers, for example. All combinations and permutations of the above described features and embodiments may be utilized in conjunction with the invention.

What is claimed is:

1. An apparatus as shown and described herein.

2. A system as shown and described herein.

3. A method as shown and described herein.

4. A non-transitory processor-readable medium comprising a plurality of processor-executable instructions that when executed by one or more processors cause the one or more processors to perform a method as shown and described herein.
